(19) United States
(12) Patent Application Publication
(10) Pub. No.: US 2026/0178577 A1
(43) Pub. Date: Jun. 25, 2026

(54) METHOD FOR SUPPORTING VECTOR PROJECTION AND SEARCH IN VECTOR DATABASE AND APPARATUS THEREOF

(71) Applicant: D.notitia.Inc., Seongnam-si (KR)

(72) Inventors: Se Hyeon OH, Seoul (KR); Moo Hyeon Nam, Seoul (KR)

(73) Assignee: D.notitia.Inc., Seongnam[si (KR)

(21) Appl. No.: 19/414,495

(22) Filed: Dec. 10, 2025

(30) Foreign Application Priority Data
Dec. 20, 2024 (KR) 10-2024-0192083

(51) Int. Cl. G06F 16/2453; G06F 16/22; G06F 16/28

(52) U.S. Cl. CPC G06F 16/24532; G06F 16/2237; G06F 16/285

(57) ABSTRACT

Provided is a method of building a vector database (DB) on a server providing a vector DB system including setting a hyperplane for projecting a cluster of vector data, generating a projection tree of the cluster, and building the vector DB by using the projection tree as an index. According to the method, a vector cluster is projected onto a hyperplane passing through its center point, thereby improving projection balance.

### CROSS-REFERENCE TO RELATED APPLICATIONS

This application claims priority under 35 U.S.C. § 119 to Korean Patent Application No. 10-2024-0192083 filed on Dec. 20, 2024, in the Korean Intellectual Property Office, the disclosures of which are incorporated by reference herein in their entireties.

### BACKGROUND

Embodiments of the present disclosure described herein relate to a method for providing search precision while efficiently using hardware resources by supporting a search based on vector projection in a vector database, and an apparatus thereof.

A vector database (vector DB) refers to a database obtained by representing and storing data objects as high-dimensional vectors. Specifically, the vector DB measures the similarity between vectors to support similarity-based search. Complex data such as images, text, and audio may be mapped into a high-dimensional vector space by using the vector DB so as to be represented. The high-dimensional vectors are typically generated through machine learning or deep learning models and have the characteristic of placing semantically similar data items close together.

A vector similarity search refers to a process of finding a vector similar to a given query vector in a vector DB. Cosine similarity, Euclidean distance, and dot product may be used as a method for measuring similarity between vectors. Through this similarity measurement method, vectors closest to the query vector may be efficiently found, and the results may be returned.

The vector similarity search is utilized in a variety of applications, such as an image search, a document search, a recommendation system, and Natural Language Processing (NLP). However, as a vector dimension increases, the computational complexity increases and memory and processing power are required. Accordingly, lightweight techniques capable of improving search efficiency while the precision of the vector search is maintained may be considered.

Korean Patent Publication No. 2023-0077251 (Publication date: Jun. 1, 2023) as a related document.

### SUMMARY

Embodiments of the present disclosure provide a vector search method that supports a vector projection-based search in a vector DB.

Embodiments of the present disclosure provide a vector search method that builds a vector DB by projecting vector data onto a hyperplane and improves search speed and accuracy.

Problems to be solved by the present disclosure are not limited to the above-described problems, and other problems not mentioned herein may be clearly understood from this specification and the accompanying drawings by those skilled in the art to which the present disclosure pertains.

According to an embodiment, a method of building a vector database (DB) on a server providing a vector DB system includes setting a hyperplane for projecting a cluster of vector data, generating a projection tree of the cluster, and building the vector DB by using the projection tree as an index.

According to an embodiment, a method of calculating a vector in a server providing a vector DB system includes computing the query and hyperplane information stored in an arbitrary node of a projection tree of a vector DB when a query is received, searching for a path of the projection tree based on the computed result, and searching for a nearest neighbor of the query and vector data belonging to the cluster when a proximity cluster is determined.

According to an embodiment, an apparatus that builds a vector DB includes a processing unit that sets a hyperplane for projecting a cluster of vector data and generates a projection tree, and a memory that stores the projection tree as an index of the vector data.

According to an embodiment, an apparatus that calculates a vector includes a vector processing unit that computes a query and hyperplane information of a cluster stored in an arbitrary node of a projection tree of a vector DB, and a control unit that searches for a path of the projection tree depending on the computed result of the vector processing unit. When a proximity cluster for the query is determined, the control unit searches for a nearest neighbor of the query and vector data belonging to the cluster.

Solutions to the problem of the present disclosure are not limited to the above-described solution, and solutions not mentioned herein may be clearly understood from this specification and the accompanying drawings by those skilled in the art to which the present disclosure pertains.

### BRIEF DESCRIPTION OF THE FIGURES

The above and other aspects of the present disclosure will become apparent to those of ordinary skill in the art by describing exemplary embodiments thereof in detail with reference to the accompanying drawings.

FIG. 1 is a flowchart for describing a process, in which a user processes and searches for data by using a vector DB system, according to an embodiment of the present disclosure.

FIG. 2 is a block diagram for describing a structure of vector search-dedicated hardware in a vector DB system, according to an embodiment of the present disclosure.

FIGS. 3A and 3B are diagrams for describing a query search method and a vector index structure generated according to an embodiment of the present disclosure.

FIG. 4 is a diagram illustrating an Approximate Nearest Neighbor Oh Yeah (ANNOY) algorithm.

FIG. 5 is a flowchart illustrating a method for clustering vector data and building a vector DB based on a projection tree.

FIG. 6 is a flowchart illustrating a method for performing a vector search in a vector DB system, according to an embodiment of the present disclosure.

FIG. 7 is a flowchart of a method for searching for a cluster in a vector DB system, according to an embodiment of the present disclosure.

FIGS. 8A and 8B are diagrams for describing an example of projecting a vector cluster onto a hyperplane, building a projection tree, and searching for a cluster, according to an embodiment of the present disclosure.

FIG. 9 is a diagram for describing a computing operating environment of a server providing a vector DB system, according to an embodiment of the present disclosure.

### DETAILED DESCRIPTION

Hereinafter, the preferred embodiments of the present disclosure are described with reference to the accompanying drawings.

However, embodiments of the present disclosure may be modified in the different forms, and the scope and spirit of the present disclosure is not limited by the embodiments to be described below. Furthermore, embodiments of the present disclosure are provided to more fully describe the present disclosure to those skilled in the art to which the present disclosure pertains.

In other words, the aforementioned objectives, features, and advantages will be described in detail below with reference to the accompanying drawings, and accordingly, those skilled in the art to which the present disclosure pertains may readily implement the technical concept of the present disclosure. In describing the present disclosure, when detailed descriptions of prior art related to the present disclosure is determined to be deemed to unnecessarily obscure the essence of the present disclosure, the detailed descriptions are omitted. Hereinafter, a preferred embodiment according to the present disclosure will be described in detail with reference to the accompanying drawings. In the drawings, the same reference numerals are used to indicate the same or similar components.

Moreover, expressions in the singular used herein include expressions in the plural unless interpreted otherwise in context. In this specification, terms such as “comprises” or “includes” should not be interpreted that a plurality of components or a plurality of steps described herein are necessarily included, and should be interpreted that some components thereof or some steps thereof are omitted, or additional components or steps are further included.

Furthermore, various components and their subcomponents are described below to describe a system according to an embodiment of the present disclosure. These components and their subcomponents may be implemented in various forms, such as hardware, software, or any combination thereof. For example, each element may be implemented as an electronic configuration for perform the corresponding function, as software itself that may be executed on an electronic system, or as a functional element of the software. Alternatively, it may be implemented as an electronic configuration and operating software corresponding thereto.

The various techniques described herein may be implemented with hardware or software, or with a combination of both where appropriate. Terms such as a “unit,” a “server,” and a “system” as used herein may similarly be treated as equivalent to computer-related entities, namely hardware, a combination of hardware and software, software, or software in execution. Also, each function executed in the system according to an embodiment of the present disclosure may be configured in units of module and may be recorded in a single physical memory or distributed and recorded across two or more memories and recording media.

Although being disclosed to describe embodiments of the present disclosure, various flowcharts are provided for the convenience of describing each step and do not necessarily mean that each step is performed in the order shown in the flowcharts. That is, steps in a flowchart may be performed simultaneously, in the order according to the flowchart, or even in the reverse order of the flowchart.

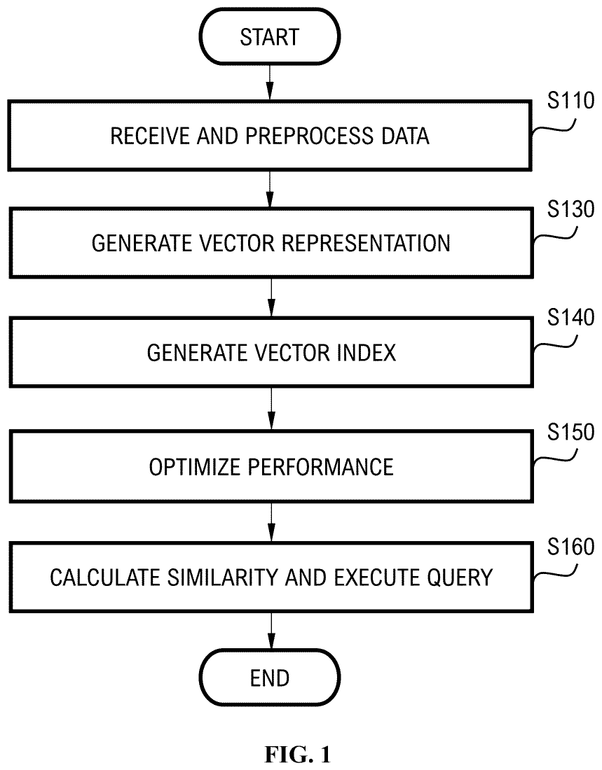

FIG. 1 is a flowchart for describing a process, in which a user processes and searches for data by using a vector DB system, according to an embodiment of the present disclosure.

In operation S110 of FIG. 1, a vector DB system may receive data from a user. The data may include both structured data and unstructured data. The vector DB system may assign a tenant for the user and may refine the data by performing duplication removal, normalization, and cleansing.

In operation S130 of FIG. 1, the vector DB system may generate and store a vector representation of the received data by using an embedding model. The vector DB system may perform vector embedding by representing structured and/or unstructured data such as text, images, voice, tables, and graphs, in a multi-dimensional vector space by reflecting data features. This enables the measurement of semantic similarity among data. The vector embedding may be performed in various ways, and the present disclosure should not be interpreted as limited to any specific method. For example, the vector representation may be extracted through an embedding model provided by the vector DB system. In another example, the vector representation may be extracted from an external embedding model linked to the vector DB system, not the embedding model provided by the vector DB system.

In operation S140 of FIG. 1, the vector DB system may generate and store an index for the vector representation of the data. The vector index is a data structure for quickly performing a similarity search between vectors. The vector index may be applied to a structure that hashes similar vectors into the same bucket, and a structure that hierarchically connects vectors with high similarity as a graph-based structure.

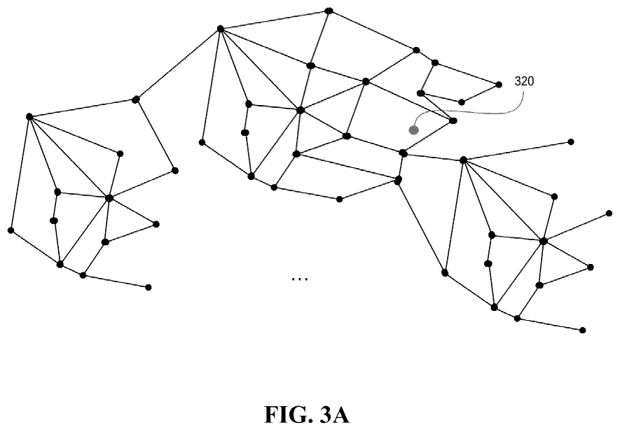

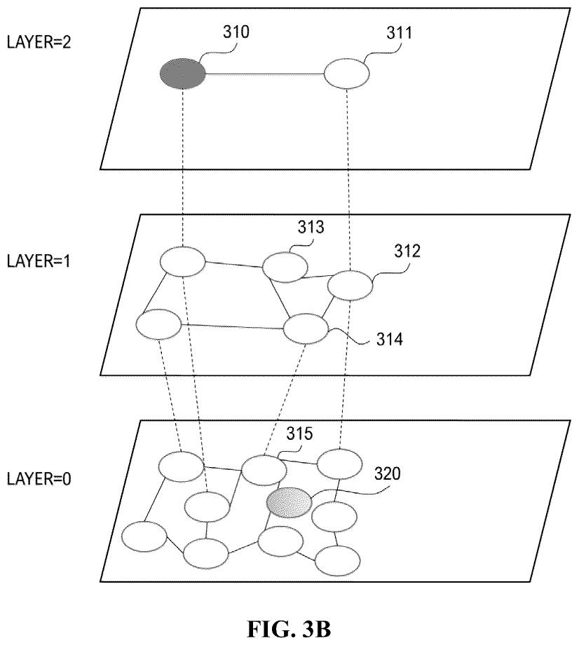

For example, a vector DB according to an embodiment of the present disclosure may generate a vector index by using a graph including a node representing a feature value of a data point in enterprise data and an edge representing the relationship between a plurality of nodes. In the case, the graph may be formed to have a hierarchical structure. For example, the vector index of the hierarchical structure may be formed by forming a plurality of layers, forming all nodes in the bottom layer, forming fewer nodes as it goes to an upper layer, and expressing relationships between layers. The vector index structure according to an embodiment of the present disclosure will be described later in the descriptions of the attached FIGS. 3A and 3B.

As another example, the vector DB may generate a vector index by projecting vector clusters with arbitrary criteria, and by using a projection tree that includes information about vector clusters and expresses relationships between vector clusters.

Furthermore, the vector DB system may apply the vector index structure in a way to increase vector search-dedicated hardware utilization efficiency. For example, the vector DB system may increase the vector search-dedicated hardware utilization efficiency by using the projection tree for upper layer searches in the vector index of the hierarchical structure. Specifically, since a small number of vector operations are performed multiple times for the upper layer of the vector index of the hierarchical structure, parallel processing of vector operations is not easy, and thus the efficiency of the vector search-dedicated hardware is low. However, the efficiency of parallel processing of vector operations can be improved by using the projection tree until an entry point is searched in the vector index of the hierarchical structure.

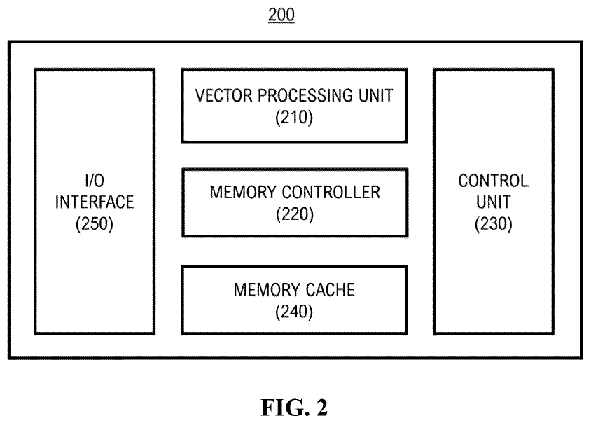

In the meantime, in operation S150 of FIG. 1, the vector DB system may perform performance optimization to efficiently search for stored vector data and vector indexes. For example, the vector DB system may include vector search-dedicated hardware to reduce CPU usage and to shorten a search time by processing large-scale vector operations in parallel. The vector DB system may efficiently perform distributed storage, clustering, and caching as well as parallel processing of vector data by using the vector search-dedicated hardware, thereby improving overall system efficiency. The structure of the vector search-dedicated hardware according to an embodiment of the present disclosure will be described later in the description of the attached FIG. 2.

In operation S160 of FIG. 1, when a query of a user is received, the vector DB system may express the query as a vector value by applying the query to the vector embedding model, may calculate a vector index for a query vector, and may search for and return vectors with high similarity. Cosine similarity or Euclidean distance may be used to calculate similarity between vectors.

For example, a method of comparing a query vector with all data points to calculate respective distances, and generating a candidate dataset sorted by proximity may be considered as a vector search method. This method is highly accurate but slow. Accordingly, a nearest neighbor search may be considered to provide a balance between search speed and search quality. In the vector DB, a nearest neighbor search algorithm is used to quickly find a neighboring vector close to a query vector in high-dimensional data. The method of calculating the similarity between the query vector and all data points has high accuracy but has a slow search speed. Accordingly, the nearest neighbor search algorithm may provide the compromise between accuracy and speed in vector search. The nearest neighbor search according to an embodiment of the present disclosure will be described below with reference to the attached FIGS. 3A and 3B.

Afterwards, the vector DB system may return the query results and may complete the process. In the case, the vector DB system may output the results to a user interface and may further perform result filtering and sorting operations.

FIG. 2 is a block diagram for describing a structure of vector search-dedicated hardware in a vector DB system, according to an embodiment of the present disclosure.

A vector search-dedicated hardware 200 according to an embodiment of the present disclosure is designed to process vector operations at high speed and to maximize the efficiency of a vector similarity search. The vector search-dedicated hardware 200 may include a vector processing unit 210, a memory controller 220, a control unit 230, a memory cache 240, and an I/O interface 250.

The vector processing unit 210 of FIG. 2 may perform high-speed calculations on large amounts of vector data through parallel processing. Vector calculations for a similarity search between a query vector and a DB vector are designed to calculate a distance such as cosine similarity distance and Euclidean distance. The vector processing unit 210 corresponds to a module optimized for high-dimensional vector operations.

The memory controller 220 of FIG. 2 may store vector data in storage and may manage memory access for reading vector data stored in the storage. The memory controller 220 features a high-bandwidth memory interface to minimize data transfer bottlenecks occurring during operations and to optimize computation speed.

The control unit 230 of FIG. 2 may control an operation of the vector search-dedicated hardware 200. The control unit 230 may schedule vector search tasks and may manage workflows between the vector processing unit 210, the memory controller 220, and the I/O interface 250. In more detail, the control unit 230 adjusts task priorities and ensures the stability and efficiency of the system. In particular, the control unit 230 according to an embodiment of the present disclosure performs a function of batching a vector to increase the speed and efficiency of parallel processing of the vector processing unit 210.

The memory cache 240 of FIG. 2 may temporarily store frequently used vector data to increase memory access speed. The memory cache 240 minimizes data access latency through a multilevel cache (e.g., L1 cache, L2 cache, etc.) and supports fast access to data repeatedly referenced during calculations.

The I/O interface 250 of FIG. 2 may process data input/output between an external data source and hardware. The I/O interface 250 supports various interfaces, such as Peripheral Component Interconnect Express (PCIe) and Ethernet, for high-speed data transmission and processes large-scale vector data in real time to integrate the processed result with a database.

The vector search-dedicated hardware 200 illustrated in FIG. 2 is a dedicated hardware configuration designed to optimize vector operations by providing a high-performance and high-efficiency vector data processing environment, thereby effectively increasing the efficiency of vector data processing and maximizing similarity search performance.

FIGS. 3A and 3B are diagrams for describing a query search method and a vector index structure generated according to an embodiment of the present disclosure.

As illustrated in FIGS. 3A and 3B, a vector index structure according to an embodiment of the present disclosure may be represented as a graph including a node representing a characteristic value of a data point and an edge representing relationships between a plurality of nodes. In the case, a graph may be formed as a planar structure, as illustrated in FIG. 3A, or may be formed as a hierarchical structure, as illustrated in FIG. 3B.

When a vector index according to an embodiment of the present disclosure is formed in a hierarchical structure, as shown in layer 0 of FIG. 3B, layer 0 being a bottom layer may include all nodes for data points and be configured by connecting only similar nodes with a horizontal edge. Furthermore, as shown in layer 1 of FIG. 3B, layer 1 being an upper layer of layer 0 may be formed by probabilistically extracting some nodes from layer 0 and connecting similar nodes among the extracted nodes with a horizontal edge. Likewise, layer 2 being an upper layer of layer 1 may be formed by probabilistically extracting some nodes from layer 1 and connecting similar nodes among the extracted nodes with a horizontal edge. The vector index structure according to an embodiment of the present disclosure may be formed to have a hierarchical structure by extracting fewer nodes as it goes to an upper layer and connecting nodes in a lower layer with similar relationships to nodes in an upper layer by using a vertical edge.

Meanwhile, when a query vector 320 is input as in examples of FIG. 3A or 3B, according to an embodiment of the present disclosure, nodes similar to the query vector 320 may be quickly found by using a vector index of FIG. 3A or a vector index of FIG. 3B. In more detail, when operations are repeated to move to a node closest to a start node by calculating a distance between the start node and each of its neighboring nodes, starting from the start node, and to move to a node closest to the corresponding node by calculating a distance between the corresponding node and each of its neighboring nodes based on the moved node, a node closest to the query vector 320 may be found quickly.

In the case, when the vector index has a hierarchical structure, as shown in FIG. 3B, a search begins at a start node 310 of layer 2 being a top layer, and then moves to a node 311 closest to the query node 320. Next, when being incapable of getting closer to the query node 320 from the node 311, it may move to a node 312 of layer 1 being a lower layer of layer 2 connected to the node 311. Next, it moves from the node 312 to a node 314 that is close to the query node 320. Next, when being incapable of getting closer to the query node 320 from the node 314, it may move to a node 315 of layer 0 being a lower layer of layer 1 connected to the node 314. The node 315 closest to the query node 320 may be quickly found by repeating this process until the closest node to the query node 320 is reached.

This search method is known as an Approximate Nearest Neighbor (ANN) index search, which enables an efficient search of the nearest data in high-dimensional data. In the ANN index search, vector similarity may be typically calculated by using an angle-based cosine similarity algorithm or a Euclidean distance-based Euclidean similarity algorithm.

Meanwhile, in a hierarchical index structure such as FIG. 3B, a vector search in a vector DB system may be performed through a traverse, which is a search process that searches for the nearest neighbor for a query by moving along a graph from a start node, i.e., an entry point. However, the upper layer may not fully utilize the vector search-dedicated hardware 200, which excels at parallel processing, because a small number of vector operations are performed multiple times. To solve the issues, according to an embodiment of the present disclosure, a vector index structure improves the efficiency of the vector search-dedicated hardware 200 in the initial traversal.

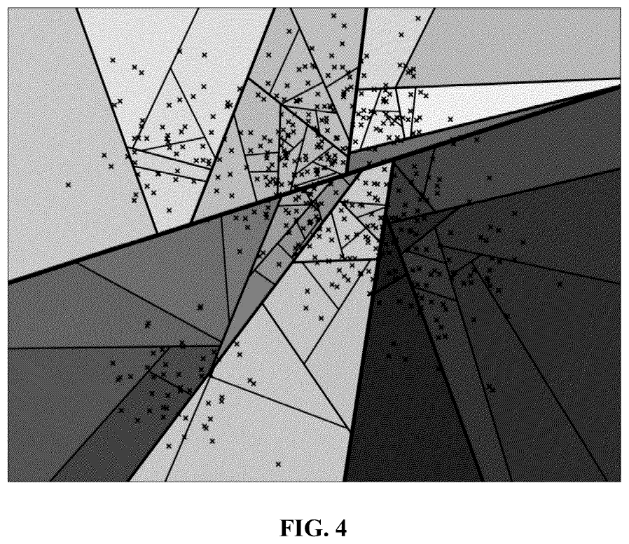

FIG. 4 is a diagram illustrating an Approximate Nearest Neighbor Oh Yeah (ANNOY) algorithm.

The ANNOY algorithm may be described as a nearest neighbor search algorithm utilizing a tree-based structure and projection. The ANNOY algorithm may include a process of partitioning data based on a hyperplane in a high-dimensional space and storing information of hyperplane in the form of a binary tree. Afterwards, during a vector search, vector data may be projected onto a specific hyperplane starting from a root node to find adjacent clusters.

However, when the ANNOY algorithm projects the hyperplane based on two randomly-selected data points within a cluster, an imbalance in the binary tree may occur depending on data distribution. The imbalance in the binary tree may degrade search efficiency. The imbalance in the binary tree occurs when the hyperplane generation process does not properly match the actual data distribution, thereby degrading clustering accuracy.

To address this issue, an embodiment of the present disclosure proposes projection criteria for clustering. In more detail, according to an embodiment of the present disclosure, vector data is projected based on a cosine distance, and a hyperplane passing through the origin and the center point of an arbitrary cluster may be presented as a projection criterion. According to the projection criterion, rather than randomly forming a hyperplane by extracting two arbitrary points of a cluster, projection is performed based on the hyperplane passing through the origin and the center point of the cluster. In this case, the hyperplane passes through the average point of all data within the cluster, and thus the possibility that data is evenly divided may be increased.

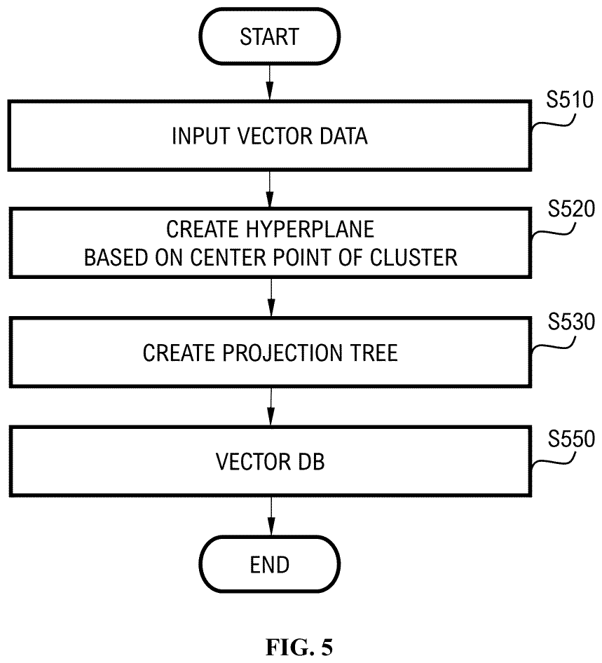

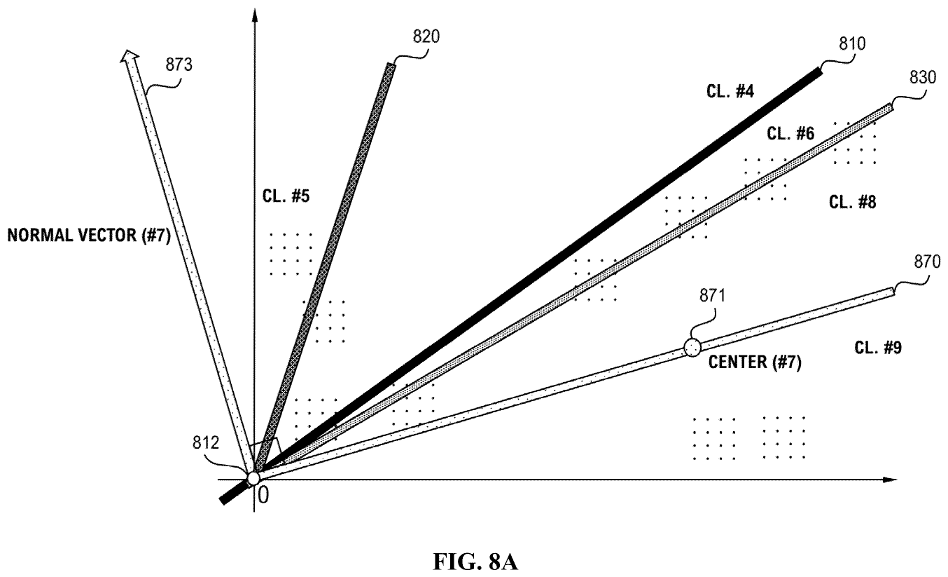

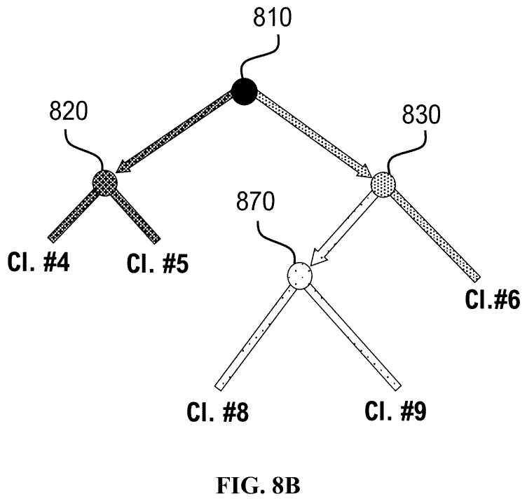

FIG. 5 is a flowchart illustrating a method for clustering vector data and building a vector DB based on a projection tree in a vector DB system, according to an embodiment of the present disclosure. FIG. 8 is a diagram for describing an example of projecting a vector cluster onto a hyperplane, building a projection tree, and searching for a cluster, according to an embodiment of the present disclosure.

According to the example of FIG. 5, a vector DB system according to an embodiment of the present disclosure may form a first cluster when vector data based on a preset criterion is input (S510).

Afterwards, the vector DB system may set a hyperplane for projecting the first cluster (S520).

In more detail, the vector DB system may set a hyperplane for projecting the first cluster based on the origin and the center point of the first cluster. A cosine distance is a value determined by an angle between two vectors relative to the origin, and thus to cluster vector data based on the cosine distance, the hyperplane is set to pass through the origin and the center point of the cluster, which is the average point of all pieces of data within the cluster. According to an embodiment, setting a hyperplane may increase the possibility that data belonging to the first cluster is evenly divided.

Furthermore, according to an embodiment of the present disclosure, the vector DB system may set a normal vector of a hyperplane to create the hyperplane passing through the origin and the center point of the first cluster. To the end, the vector DB system may obtain a vector perpendicular to a vector passing through the origin and the center point of the first cluster. For example, when the center point of the first cluster is (a, b), one of the vectors perpendicular to vector (a, b) may be a vector (b, −a). One of the vectors perpendicular to a high-dimensional vector (a₁, a₂, a₃, a₄, . . . , aₙ₋₁, aₙ) with even dimension may be a vector (a₂, −a₁, a₄, −a₃, . . . , aₙ, −aₙ₋₁). In this way, the vector DB system may set, as the normal vector, any vector of vectors perpendicular to a vector passing through the origin and the center point of the first cluster.

As such, when the origin, the center point of the first cluster, and the normal vector are set, the first hyperplane for the projection of the first cluster may be set.

In the meantime, after the vector space is partitioned into a first hyperplane, when vector data based on a preset criterion is input into the vector DB system, the vector DB system may form a second cluster on one side of the first hyperplane and a third cluster on the other side.

Afterwards, the vector DB system may set a hyperplane for projecting a second cluster and a hyperplane for projecting a third cluster. In more detail, when the origin, the center point of the second cluster, the center point of the third cluster, and a normal vector perpendicular to a vector passing through the origin and the center point of the second cluster, and a normal vector perpendicular to a vector passing through the origin and the center point of the third cluster are set, a second hyperplane for projecting the second cluster is set and a third hyperplane for projecting the third cluster is set, and the vector space may be partitioned by using these hyperplanes.

In this way, as the vector data continues to be input into the vector DB system, a hyperplane for projecting a target cluster may be set on a target vector space. For a more detailed explanation, descriptions will be given with reference to FIG. 8A.

In the example shown in FIG. 8A, the first cluster, the second cluster, and the third cluster, which are initially formed when the vector data is input, are projected onto a first hyperplane 810, a second hyperplane 820, and a third hyperplane 830, respectively.

When data is continuously input in this state, a seventh cluster may be formed on one side of the third hyperplane 830, a normal vector 873 of a vector connecting an origin 812 and a center point 871 of the seventh cluster may be calculated, and a seventh hyperplane 870 for the projection of the seventh cluster may be formed with the center point 871 of the seventh cluster, the origin 812, and the normal vector 873. When the seventh hyperplane 870 is formed, the seventh cluster logically disappears, and the seventh hyperplane 870 and two clusters on either side of the seventh hyperplane 870 may be formed.

In more detail, an eighth cluster may be formed on one side of the seventh hyperplane 870; a ninth cluster may be formed on the other side thereof; a fourth cluster may be formed on one side of the second hyperplane 820; and a fifth cluster may be formed on the other side thereof. Each cluster may form a hierarchical structure with its own hyperplane.

Returning to the description of FIG. 5, when a hyperplane for projection of cluster is set and a cluster is formed in the space divided by the hyperplane, the vector DB system may create a projection tree including projection information for vector data and may manage the created projection tree (S530).

In more detail, according to an embodiment of the present disclosure, the top node of the projection tree is a root node, and a hyperplane node, which is a branch node serving as an intermediate node, may store information about the corresponding hyperplane and information about its child node. The hyperplane node may be configured as a union structure having the normal vector of the hyperplane used for projection, a left child and a right child. A cluster node, which is a leaf node, may not be stored individually but may be stored in a parent node. That is, the cluster node may not exist independently and may be managed in a dependent manner under a parent hyperplane node.

FIG. 8B illustrates a projection tree for the vector data of FIG. 8A formed according to an embodiment of the present disclosure. In the projection tree of FIG. 8B, the nodes 810, 820, 830, and 870 represent hyperplanes including cluster projection information. Furthermore, the projection tree of FIG. 8B represents fourth and fifth clusters formed on both sides of the vector space partitioned by the hyperplane 820, and the eighth and ninth clusters formed on both sides of the vector space partitioned by the hyperplane 870.

Returning to the description of FIG. 5, the vector DB system may configure a vector DB by using a projection tree as an index (S550).

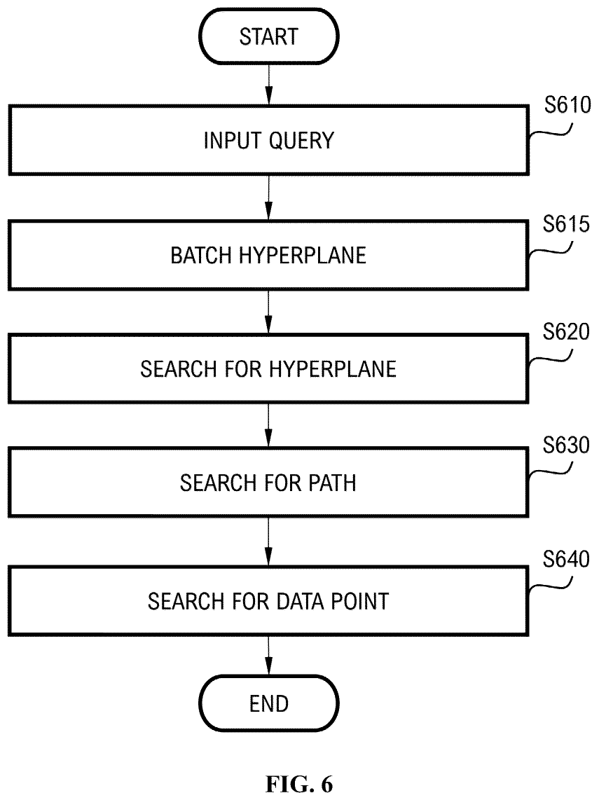

FIG. 6 is a flowchart illustrating a method for performing a vector search in a vector DB system, according to an embodiment of the present disclosure.

When a query is entered into the vector DB system (S610), a search for the nearest cluster for a query may be performed by moving along a tree from a root node in a projection tree structure.

In this case, when utilizing the vector search-dedicated hardware 200, the vector DB system may increase the number of operations processed at once based on a batch of hyperplanes to improve the parallel processing speed and efficiency of the vector processing unit 210 (S615).

In more detail, in the vector DB system, instead of the vector processing unit 210 computing the first hyperplane 810 depending on a hierarchical structure of the projection tree, searching for the path of the projection tree based on the computational results, sequentially computing the second hyperplane 820 and the third hyperplane 830, which are sub-hyperplanes of the first hyperplane 810, and searching the path of the projection tree according to the calculation result, the control unit 230 may batch the first hyperplane 810, the second hyperplane 820, and the third hyperplane 830 such that they may be processed simultaneously in a single bundle, to increase the parallel processing speed and efficiency of the vector processing unit 210. According to an embodiment of the present disclosure, the batch of hyperplanes may be set based on a batch size (ie. an amount to be computed at once), regardless of the hierarchical structure of the projection tree. In this case, the control unit 230 may perform a path search of the projection tree in unit of batch size by identifying the computational results for a plurality of hyperplanes. That is, at a point in time when it searches for any hyperplane node in the projection tree, it may simultaneously compute hyperplanes of the hyperplane node and its child nodes by the number of batch size at once, and may search for the path of the projection tree by identifying the computed results.

In the meantime, a cluster search according to an embodiment of the present disclosure performs a search for the nearest cluster for a query by moving along the tree from the root node in the projection tree (S620).

In more detail, the vector DB system may project a query onto a target hyperplane stored in the node at any node in the projection tree. This corresponds to an operation that takes the inner product of the query with the normal vector of the hyperplane.

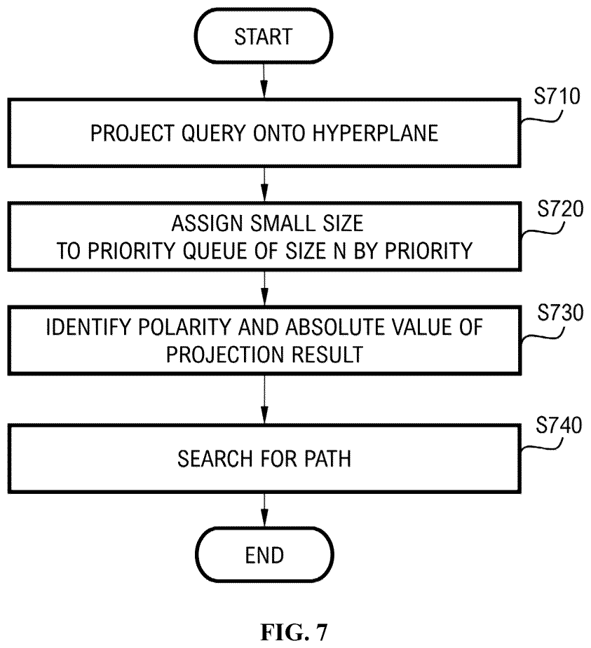

Afterwards, the vector DB system may search for the path of the projection tree by identifying the projection result value (S630). In detail, the polarity of the projection result value indicates the direction of the hyperplane and the query, and the magnitude of the projection result value indicates the distance between the query and the hyperplane. Accordingly, when the inner product between the query and the normal vector of the hyperplane is greater than or equal to 0, the query may be located to the left of the hyperplane, and thus the vector DB system may search for the path of the projection tree to the left child node of the node in which the hyperplane is stored. When the inner product between the query and the normal vector of the hyperplane is less than 0, the query may be located to the right of the hyperplane, and thus the vector DB system may search for the path of the projection tree to the right child node of the node in which the hyperplane is stored. A more detailed description of the method for searching for the nearest cluster of a query based on the projection tree is provided below with reference to the attached FIG. 7.

When the closest cluster for a query is determined, the vector DB system may search for the nearest neighbor of the query with respect to vector data belonging to the determined cluster and may return the search results for the query (S640).

For example, when the size of the vector data belonging to the nearest cluster is less than or equal to a specific size, the vector DB system may calculate the distance from the query for all pieces of vector data and may extract K data points with the closest calculated distance. As another example, when the size of the vector data belonging to the closest cluster exceeds the specific size, the vector DB system may configure a vector index for the cluster and may extract the nearest data points by using the configured vector index.

After searching for the nearest cluster, the algorithm for searching for the nearest data points may be determined in an advantageous manner depending on the size of the vector data stored in the cluster and/or the configuration of the vector DB system. For example, on the basis of the size of the vector data, the vector index may be dynamically designed to be configured when the vector data having the specific size or more is loaded into the vector DB, thereby improving search efficiency.

FIG. 7 is a flowchart of a method for searching for a cluster in a vector DB system, according to an embodiment of the present disclosure.

When a query is received, the vector DB system may project a query onto a hyperplane by using a projection tree (S710). For example, the vector DB system may compute the inner product of the query and the normal line of an arbitrary hyperplane.

In the case, a case where the query is close to the hyperplane may be considered. This means that the distance between the query vector and the hyperplane is close and the query vector almost overlaps the hyperplane. In this case, the polarity of the inner product result may be unreliable for distinguishing clusters. The reason is that when the absolute value of the inner product result approaches 0, the vector actually overlaps the hyperplane, making it difficult to clearly determine a cluster to which the vector belongs.

For example, when the query is very close to the third hyperplane 830 in the projection tree in FIG. 8B, the absolute value of the inner product result between the query and the normal vector of the third hyperplane 830 may be very small. For example, it is assumed that the absolute value of the result of projecting the query onto the third hyperplane 830 is 0.0001. In this case, either searching for the seventh hyperplane 870 in the projection tree of FIG. 8B because the polarity of the projection result value indicates that the projection result value is less than 0, or determining the sixth cluster as the nearest cluster because the polarity of the projection result value indicates that the projection result value is greater than or equal to 0 may lead to reduced accuracy due to the possibility that the nearest data point is present in a different direction. Accordingly, it may be appropriate to search for all sub-nodes of the node 830 representing the third hyperplane 830.

When a plurality of sub-nodes in a hyperplane adjacent to the query are included, performing projection on all the sub-nodes may lead to inefficient use of resources and the degradation of overall system performance. Accordingly, according to an embodiment of the present disclosure, a priority queue that prioritizes a projection result of a small level (i.e., a small absolute value) may be utilized (S720). In this case, the system may be implemented to exclude the sub-node whose projection result value exceeds the size of a priority queue, and to search for only the sub-node whose projection result value falls within a specific range. According to an embodiment of the present disclosure, the trade-off between performance and accuracy may be adjusted by adjusting the size of the priority queue.

Accordingly, the vector DB system may identify the smallest value in the priority queue (S730). The vector DB system may select the left child when the projection result value is greater than or equal to 0, or may select the right child when the projection result value is less than 0, and then may search for a path (S740). In the meantime, when the projection result value is less than or equal to a preset threshold value, the vector DB system may select all sub-children as projection targets and then may search for a path (S740).

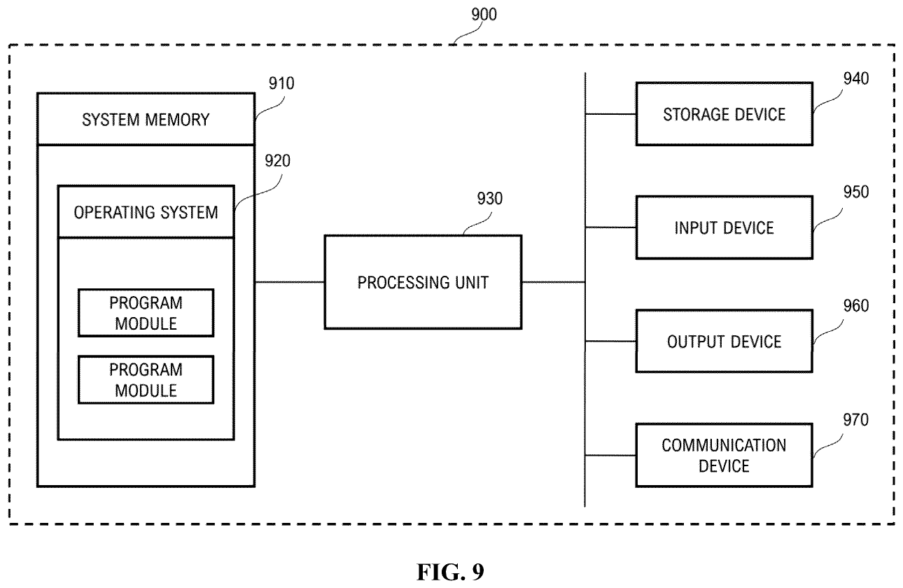

FIG. 9 is a diagram for describing a computing operating environment of a server providing a vector DB system, according to an embodiment of the present disclosure.

FIG. 9 is designed to provide a general and simplified description of a suitable computing environment in which embodiments of a system server are capable of being implemented. Referring to FIG. 9, a computing device 900 is illustrated as an example of a system server.

The computing device 900 may include at least a processing unit 930 and a system memory 910.

The computing device 900 may also include a plurality of processing units that cooperate in executing a program.

Depending on the exact configuration and type of the computing device 900, a system memory 910 may be volatile memory (e.g., RAM), nonvolatile memory (e.g., ROM, flash memory, etc.), or a combination thereof. The system memory 910 includes a suitable operating system 920 for controlling the operation of the platform, such as the WINDOWS operating system from Microsoft Corporation. The system memory 910 may include one or more software applications, such as program modules or applications

The computing device 900 may include additional storage devices 940, such as magnetic disks, optical disks, or tapes. Such additional storage device 940 may be removable storage and/or fixed storage. Computer-readable storage media may include volatile and non-volatile media and removable and stationary media that are implemented for storing information, such as computer-readable instructions, data structures, program modules, or other data, using any method or technique.

Both the system memory 910 and the storage device 940 are all examples of computer-readable storage media. The computer-readable storage media may include, but is are not limited to, memory devices such as a random access memory (RAM), a read-only memory (ROM), an electrically erasable programmable read-only memory (EEPROM), a flash memory, and others, optical storages such as a compact disc read only memory (CD-ROM), a digital versatile disk (DVD) or other optical storage, magnetic tape, magnetic disk storage, and others, and any other medium capable of storing desired information and being accessed by the computing device 900.

An input device 950 of the computing device 900 may include, for example, a keyboard, a mouse, a pen, a voice input device, a touch input device, and comparable input devices. The input device 950 is well known in the art, and therefore, a detailed description thereof will be omitted.

An output device 960 of the computing device 900 may include, for example, a display, a speaker, a printer, and other types of output devices. The output device 960 is well known in the art, and therefore, a detailed description thereof will be omitted.

The computing device 900 may also include a communication device 970 that allows the computing device 900 to communicate with other devices over, for example, a distributed computing environment network, such as a wired or wireless network, a satellite link, a cellular link, or a short-range network, using comparative mechanism. The communication device 970 is one example of a communication medium, which may include computer-readable instructions, data structures, program modules, or other data therein. Examples of the communication medium may include, but is not limited to, wired media such as a wired network and direct-wired connection, and wireless media such as acoustic, a radio frequency (RF), infrared rays, and others.

Methods according to various embodiments of the present application may be implemented in a form of program instructions that may be executed through various computing devices and may be recorded in a computer-readable recording medium. The computer-readable recording medium may include program instructions, data files, data structures or the like, alone or a combination thereof. The program instructions recorded in the computer-readable recording medium may be specially designed and configured for the embodiments or be known to those skilled in a field of computer software. Examples of the computer-readable recording medium may include a magnetic media such as a hard disk, a floppy disk, or a magnetic tape; an optical medium such as a compact disk read only memory (CD-ROM) or a digital versatile disk (DVD); a magneto-optical medium such as a floptical disk; and a hardware device specially configured to store and execute program commands, such as a ROM, a random access memory (RAM), a flash memory, or the like. Examples of the program instructions include high-level language codes capable of being executed by a computer using an interpreter or the like, as well as machine language codes made by a compiler. The above-described hardware device may be constituted to be operated as one or more software modules to perform the operations of the embodiments, and vice versa.

According to an embodiment of the present disclosure, a vector cluster may be projected onto a hyperplane passing through its center point, thereby improving projection balance. Furthermore, according to an embodiment of the present disclosure, based on the batch of hyperplanes, a lot of vector operations may be requested simultaneously on vector search-dedicated hardware, thereby increasing the efficiency of a vector DB system.

Effects of the present disclosure are not limited to the above-described effects, and any other effects not mentioned herein may be clearly understood from this specification and the accompanying drawings by those skilled in the art to which the present disclosure pertains.

Embodiments have been described hereinabove by restrictive examples and drawings, but various modifications and variations may be made from the above description by those skilled in the art. For example, even though the described technologies are performed in an order different from that of the described method, and/or components of the described system, structure, device, circuit, and the like may be coupled to or combined with each other in a form different from that of the described method, or are replaced by other components or their equivalents, appropriate results may be achieved.

Therefore, other implementations, other embodiments, and equivalents of the claims fall within the scope of the following claims.

What is claimed is:

1. A method of building a vector database (DB) on a server providing a vector DB system, the method comprising:
setting a hyperplane for projecting a cluster of vector data;
generating a projection tree of the cluster; and
building the vector DB by using the projection tree as an index.

2. The method of claim 1, wherein the setting of the hyperplane includes:
setting the hyperplane by using an origin of a vector space, a center point of the cluster, and a normal vector of a vector connecting the origin and the center point of the cluster.

3. The method of claim 1, wherein the generating of the projection tree includes:
generating the projection tree by including a root node, a hyperplane node that stores information about a normal vector of the hyperplane and a child node, and a cluster node stored dependent on a parent node.

4. A method of calculating a vector in a server providing a vector DB system, the method comprising:
when a query is received, computing the query and hyperplane information stored in an arbitrary node of a projection tree of a vector DB;
searching for a path of the projection tree based on the computed result; and
when a proximity cluster is determined, searching for a nearest neighbor of the query and vector data belonging to the cluster.

5. The method of claim 4, wherein the searching for the path of the projection tree includes:
searching for the path of the projection tree depending on polarity of a result obtained by performing an inner product on the query and a normal vector of a hyperplane of a cluster stored in the node.

6. The method of claim 4, wherein the searching for the path of the projection tree includes:
when the query approaches a hyperplane of a cluster stored in the node beyond a predetermined range, searching for all sub-nodes of the node in the projection tree, regardless of polarity of a result obtained by performing an inner product on the query.

7. The method of claim 4, wherein the computing of the query includes:
setting a batch of a plurality of hyperplanes stored in an arbitrary node of the projection tree with an arbitrary size regardless of a hierarchical structure of the projection tree; and
processing the plurality of hyperplanes and the query in a single parallel processing.

8. An apparatus that builds a vector DB, the apparatus comprising:
a processing unit configured to set a hyperplane for projecting a cluster of vector data and to generate a projection tree; and
a memory configured to store the projection tree as an index of the vector data.

9. An apparatus that calculates a vector, the apparatus comprising:
a vector processing unit configured to compute a query and hyperplane information of a cluster stored in an arbitrary node of a projection tree of a vector DB; and
a control unit configured to search for a path of the projection tree depending on the computed result of the vector processing unit,
wherein when a proximity cluster for the query is determined, the control unit searches for a nearest neighbor of the query and vector data belonging to the cluster.
